(19) United States
(12) Patent Application Publication
(10) Pub. No.: US 2012/0203956 A1
(43) Pub. Date: Aug. 9, 2012

(54) RECORDING DEVICE, CONTROL METHOD FOR RECORDING DEVICE, AND RECORDING MEDIUM

(75) Inventor: Shunichi Wakasa, Chikuma-shi (JP)

(73) Assignee: SEIKO EPSON CORPORATION, Shinjuku-ku (JP)

(21) Appl. No.: 13/368,281

(22) Filed: Feb. 7, 2012

(30) Foreign Application Priority Data
Feb. 8, 2011 (JP) 2011-024682

(51) Int. Cl. G06F 12/00

(52) U.S. Cl. 711/103; 711/E12.008

(57) ABSTRACT

A recording device with nonvolatile memory suppresses the number of times the nonvolatile memory is written, avoiding memory failure and increasing printer 12 life. The printer 12 has nonvolatile memory 35, and a printer control unit 30 that executes commands based on a command and initialization values table 43 when executing an initialization process. Of the commands contained in the command and initialization values table 43, the printer control unit 30 does not execute a currency symbol write process command TC, which is a command related to a process involving writing to nonvolatile memory 35, more than a specific number of times.

This application claims priority under 35 U.S.C. §119 to Japanese Patent Application No. 2011-24682 filed on Feb. 8, 2011, the entire disclosure of which is expressly incorporated by reference herein.

### BACKGROUND

1. Technical Field

The present invention relates to a recording device that records on a recording medium, a method of controlling the recording device, and a recording medium storing a program for controlling the recording device.

2. Related Art

Recording devices that have nonvolatile memory such as EEPROM or flash ROM devices are known from the literature. See, for example, Japanese Unexamined Patent Appl. Pub. JP-A-2010-36498.

Such recording devices access the nonvolatile memory as needed to read and write data in the nonvolatile memory.

Nonvolatile memory devices such as EEPROM and flash ROM have a finite number of program/erase (write) cycles guaranteed by the manufacturer, such as 5000 P/E cycles. Failure results when the number of writes exceeds this rating. The number of write cycles guaranteed for nonvolatile memory is less than the number of write cycles guaranteed for volatile memory devices such as RAM. It is therefore necessary in recording devices with nonvolatile memory such as described above to avoid writing to nonvolatile memory unnecessarily and prevent the nonvolatile memory from wearing out (failing) in order to increase the service life of the recording device.

### SUMMARY

The invention increases the service life of a recording device having nonvolatile memory by suppressing the number of times the recording device writes to nonvolatile memory.

A first aspect of the invention is a recording device that records to a recording medium, including: nonvolatile memory that stores a data table including commands that are executed when a specific (defined) event occurs and execution counts defining how many times each command can be executed; and a control unit that executes the commands contained in the data table when the specific event occurs; the commands in the data table including a command that writes specific (defined) information to the nonvolatile memory; and the control unit executing said command within the range of the execution count.

The invention thus described can prevent executing commands that are executed when specific events occur and are among the commands contained in a data table that are related to processes accompanied by writing to nonvolatile memory more than the number of write cycles assured by the manufacturer of the nonvolatile memory, and can suppress the number of times data is written to the nonvolatile memory.

A recording device according to another aspect of the invention preferably also has volatile memory, and the control unit reads and writes the execution counts from the nonvolatile memory to the volatile memory, decrements the execution count in the volatile memory when said command is executed, and reads and writes the execution count from the volatile memory to the nonvolatile memory before the recording device power turns off.

This aspect of the invention can suppress the number of times data is written to nonvolatile memory because the control unit uses volatile memory to store and overwrite variables that are frequently updated, such as the execution count.

In a recording device according to another aspect of the invention, the control unit deletes from the commands contained in the data table any command for which the execution count is 0.

When the execution count reaches the value set as the write cycle count of the nonvolatile memory, a command involved with writing to nonvolatile memory is removed from the data table. As a result, the next time the specific event occurs and the data table is referenced, there is no need for a process that determines if the command should be executed, and command processing is more efficient.

In a recording device according to another aspect of the invention, the execution count is within the guaranteed number of write cycles of the nonvolatile memory.

This aspect of the invention avoids nonvolatile memory failures.

Yet further preferably, the recording device can connect to a computer; the recording device power turning on, receiving a specific (defined) command related to an initialization process from the computer, and specific (defined) input from an input unit of the recording device, are included in the specific events; and the control unit executes a command contained in the data table when any one of the specific events is detected.

When initializing the recording device is triggered by specific defined events, this aspect of the invention can suppress the number of times processes accompanied by writing to nonvolatile memory execute.

In another aspect of the invention, the commands contained in the data table are in an form that the control unit can receive from the computer and execute.

With this aspect of the invention, commands read from the data table can be executed by the same process used for commands received from the computer, and a special process is not needed.

In another aspect of the invention, the commands contained in the data table include a command that writes specific (defined) font data to the nonvolatile memory.

When initialization of the recording device involves changing font data, this aspect of the invention can suppress the number of times data is written to nonvolatile memory.

In another aspect of the invention, firmware of which at least part is common to a different recording device is stored in the nonvolatile memory; and the commands contained in the data table include a command that performs a different process or setting than the different recording device.

Of the commands that are executed when triggered by specific events, commands that are also executed by a different recording device are included in common firmware, and other commands are included in the data table and executed separately. Because the initialization process, for example, can be easily changed by simply changing the data table, efficiency can be improved when developing a plurality of recording devices, and customization (changing specifications) for different destinations and custom specifications can be easily accommodated.

Another aspect of the invention is a method of controlling a recording device that includes nonvolatile memory storing a data table including commands that are executed when a specific event occurs and execution counts defining how many times each command can be executed, and a control unit that executes the commands contained in the data table when the specific event occurs, and records to a recording medium, wherein: the commands in the data table including a command that writes specific (defined) information to the nonvolatile memory; and said command is executed within the range of the execution count.

The control method according to this aspect of the invention can prevent executing commands that are executed when specific events occur and are among the commands contained in a data table that are related to processes accompanied by writing to nonvolatile memory more than the number of write cycles assured by the manufacturer of the nonvolatile memory, and can suppress the number of times data is written to the nonvolatile memory.

Another aspect of the invention is a recording medium that can be installed in a recording device that includes nonvolatile memory storing a data table including commands that are executed when a specific event occurs and execution counts defining how many times each command can be executed, and a control unit that executes the commands contained in the data table when the specific event occurs, and records to a recording medium, the recording medium storing a program that is executed by the control unit wherein: the commands in the data table including a command that writes specific information to the nonvolatile memory; and the program causes the control unit to execute said command within the range of the execution count.

By executing this program, execution of commands that are executed when specific events occur and are among the commands contained in a data table that are related to processes accompanied by writing to nonvolatile memory more than the number of write cycles assured by the manufacturer of the nonvolatile memory can be prevented, and the number of times data is written to the nonvolatile memory can be suppressed.

### Effect of the invention

The invention can suppress the number of times nonvolatile memory is written in a recording device having nonvolatile memory, and can increase the life of the recording device.

### BRIEF DESCRIPTION OF THE DRAWINGS

FIG. 1 is a block diagram showing the functional configuration of a recording system according to a preferred embodiment of the invention.

FIG. 2 shows an example of a code page.

FIG. 3 shows an example of a command and initialization values table.

FIG. 4 is a flow chart of printer operation.

FIG. 5 is a flow chart of printer operation.

FIG. 6 is a flow chart of printer operation.

### DESCRIPTION OF EMBODIMENTS

A preferred embodiment of the present invention is described below with reference to the accompanying figures.

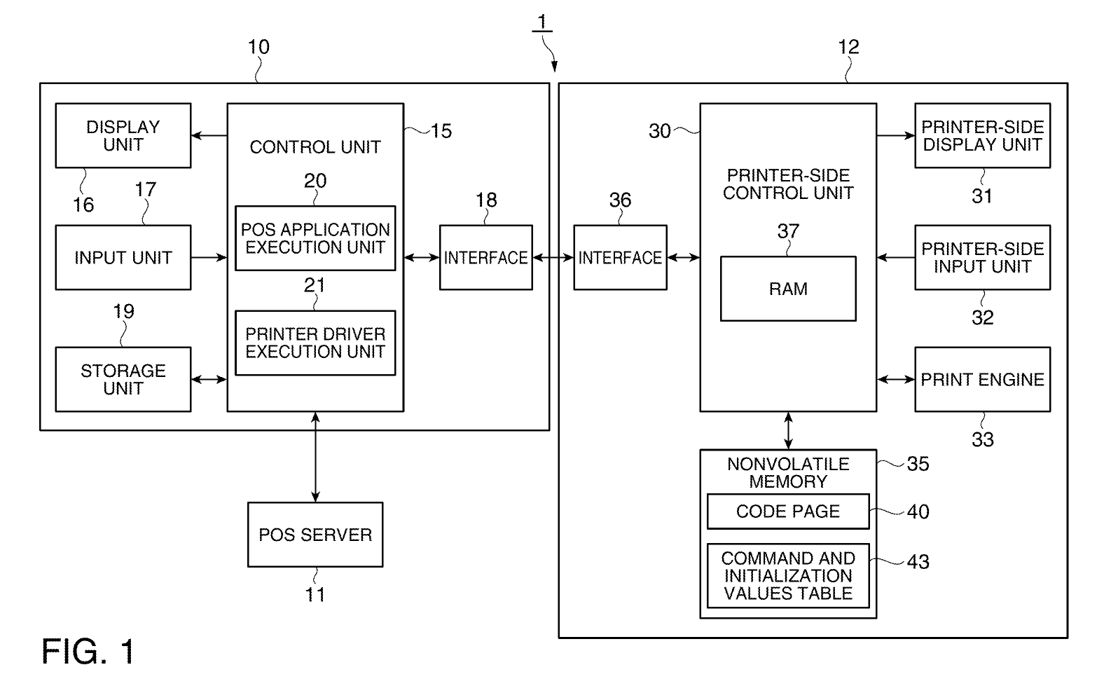

FIG. 1 is a block diagram showing the functional configuration of a recording system 1 according to this embodiment of the invention.

The recording system 1 is used in retail stores such as supermarkets and convenience stores to issue receipts for bill and purchase payments by customers visiting the store, and as shown in FIG. 1 includes a host computer 10, POS server 11, and printer 12 (recording device).

The POS server 11 is connected to and communicates with the host computer 10 over a network, and stores data for information required to execute a payment process and print receipts, including product code, name, and price information for products sold by the store, in a database. In order to issue a receipt, the host computer 10 references the database stored on the POS server 11 as needed to acquire the required information.

The host computer 10 has a control unit 15, display unit 16, input unit 17, interface 18, and storage unit 19.

The control unit 15 centrally controls other parts of the host computer 10, and includes a CPU as an operating unit, ROM that nonvolatilely stores the basic control program run by the CPU and data related to the basic control program, RAM that temporarily stores programs run by the CPU and data related to the programs, and other appropriate peripheral circuits.

As shown in FIG. 1, the control unit 15 includes a POS application execution unit 20 and a printer driver execution unit 21.

The display unit 16 is a display panel such as an LCD panel or organic EL panel, and displays information on the display panel as controlled by the control unit 15.

The input unit 17 is connected to input devices such as a keyboard, mouse, barcode reader, and card reader, and outputs output signals from these input devices to the control unit 15. The barcode reader is used to read barcodes recorded on product packaging, for example, and the card reader is used to read information recorded on credit cards and membership cards, for example. Information acquired using the barcode reader, card reader, or other input device is used to process payments and print receipts.

The interface 18 communicates with the printer 12 as controlled by the control unit 15 according to a specific communication protocol.

The storage unit 19 rewritably stores data, and includes a storage device such as a hard disk drive, EEPROM, or flash ROM.

The printer 12 is a printer with a thermal head that conveys thermal paper wound in a roll (thermal roll paper) using a platen roller, records images by applying heat to the recording surface of the thermal roll paper using a line thermal head with heating elements, and then cuts the thermal roll paper at a specific (defined) position, producing a receipt.

As shown in FIG. 1, the printer 12 has a printer control unit 30 (control unit), printer display unit 31, printer input unit 32, print engine 33, nonvolatile memory 35 (storage unit), and interface 36.

The printer control unit 30 includes a CPU, and centrally controls other parts of the printer 12 by the CPU reading and running firmware or another program stored in nonvolatile memory 35, or writing and running some part of the program from RAM 37 (memory).

RAM 37 is memory having storage areas for temporarily storing data, and more particularly provides working memory for temporarily storing data used for program execution. RAM 37 is volatile memory, and can hold data as long as power is supplied, such as while the printer 12 power is on.

The printer display unit 31 has LEDs or a display panel such as an LCD panel or organic EL panel for displaying information such as the operating status of the printer 12, and displays information on the display panel, or turns particular LEDs on/off, as controlled by the printer control unit 30.

The printer input unit 32 is connected to operating switches disposed to a panel on the printer 12, for example, detects operation of the switches, and outputs corresponding operating signals to the printer control unit 30.

The print engine 33 drives the foregoing line thermal head, a paper feed motor for driving the platen roller that conveys the thermal roll paper, and a cutter drive motor that drives the cutter of a paper cutter mechanism, while monitoring the output values of sensors that detect, for example, the position, size, and type of paper, as controlled by the printer control unit 30 to record images on the thermal roll paper, cut the thermal roll paper after image recording, and thereby issue a receipt.

The interface 36 communicates with the host computer 10 as controlled by the printer control unit 30 according to a specific communication protocol such as the USB standard.

The nonvolatile memory 35 is an EEPROM, flash ROM, or other type of nonvolatile memory device, and stores data rewritably. In addition to storing firmware for controlling printer 12 operation, the nonvolatile memory 35 also stores a code page 40 and command and initialization values table 43 (information list). Data stored in nonvolatile memory 35 is retained even when power is not supplied, such as when the printer 12 power is off.

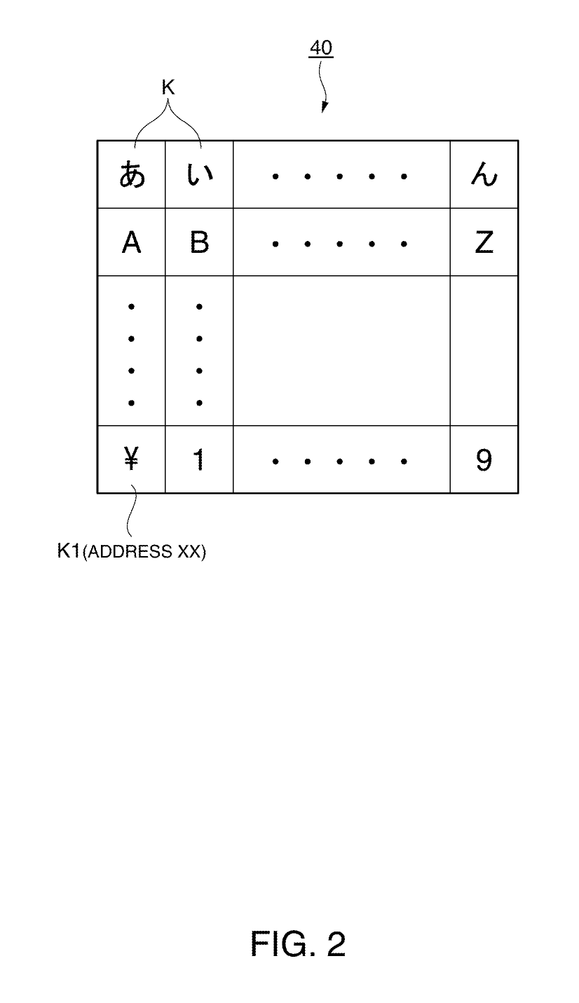

FIG. 2 schematically describes the content of the code page 40.

The code page 40 is a table that stores data for plural fonts of characters that can be recorded by the printer 12. The font data is the actual data (such as bitmap font data or scalable font data) expressing the characters in a format that can be recorded on the recording medium.

As shown in FIG. 2, the code page 40 has a plurality of storage areas k formed by segmenting and allocating the storage space of the code page 40, and the data for one font can be stored in one storage area k.

An address that uniquely identifies each storage area is assigned to each storage area k based on the address of the first cell, and one storage area k can be identified and the font data stored therein can be read by identifying one address.

In this embodiment of the invention as shown in FIG. 2, font data for the Japanese currency symbol ¥ is stored in storage area k1 at address XX in the group of storage areas k formed in the code page 40.

The basic operation of the recording system 1 when issuing a receipt is described next by describing the POS application execution unit 20 and printer driver execution unit 21.

The POS application execution unit 20 executes a POS application that is preinstalled to the host computer 10. Based on product information input from the input unit 17, such as barcode information acquired by scanning product barcodes with a barcode scanner, the POS application accesses the POS server 11 to acquire the information to be printed on the receipt. This information includes, for example, information identifying the products purchased in the transaction, information indicating product prices, and information indicating the total purchase amount. Based on the acquired information, the POS application execution unit 20 also processes payment and generates recoding data for the image to be recorded on the receipt, and outputs the recoding data to the printer driver execution unit 21. The content recorded on the receipt may include the store logo, characters indicating product names, and characters indicating prices, for example. In the recoding data generated by the POS application execution unit 20, these characters are expressed by specific (defined) character codes, such as Unicode.

The printer driver execution unit 21 runs a printer driver preinstalled in the host computer 10. The printer driver generates recording commands according to the command language of the printer 12 based on the recoding data input from the POS application execution unit 20, and outputs to the printer control unit 30. Character codes are included in the recoding data. The recording commands include commands causing the paper feed mechanism to convey the thermal roll paper, commands for driving the line thermal head, commands for causing the cutter mechanism to cut the thermal roll paper, and other commands that cause the printer 12 to produce a receipt.

The printer control unit 30 controls parts of the printer 12 based on the input recording commands to produce a receipt.

Character code processing by the printer driver execution unit 21 is described next.

When recoding data is input from the POS application execution unit 20, the printer driver execution unit 21 interprets the recoding data and extracts the character codes contained in the recoding data.

The printer driver execution unit 21 then converts the extracted character codes to address information. This address information is information indicating the address of the storage area k storing the font data for the characters of the extracted character codes. Note that a table correlating the character codes and address information is stored in the storage unit 19, and the printer driver execution unit 21 reads this table to convert character codes to address information. For example, for the character code identifying the Japanese currency symbol ¥, the printer driver execution unit 21 converts the character code to address information indicating address XX.

The printer driver execution unit 21 outputs the recording commands to the printer 12 after converting the character codes to address information.

The character codes could be converted to address information on the printer 12 side. In this case, the printer driver execution unit 21 outputs the character codes contained in the recoding data to the printer 12. A table relating character codes to address information is stored in nonvolatile memory 35, and the printer control unit 30 converts the character codes to address information.

When recording commands and address information are input, the printer control unit 30 controls the print engine 33 based on the recording commands to produce a receipt. The printer control unit 30 therefore determines the storage area in the code page 40 of the characters to be recorded on the receipt based on the address information, reads the font data stored at the identified storage area, and records an image of each character. For example, the printer control unit 30 identifies storage area k1 in the code page 40 based on address information identifying address XX, reads the font data stored at the identified storage area k1, and records the font data of the currency symbol on thermal roll paper.

The command and initialization values table 43 is described next.

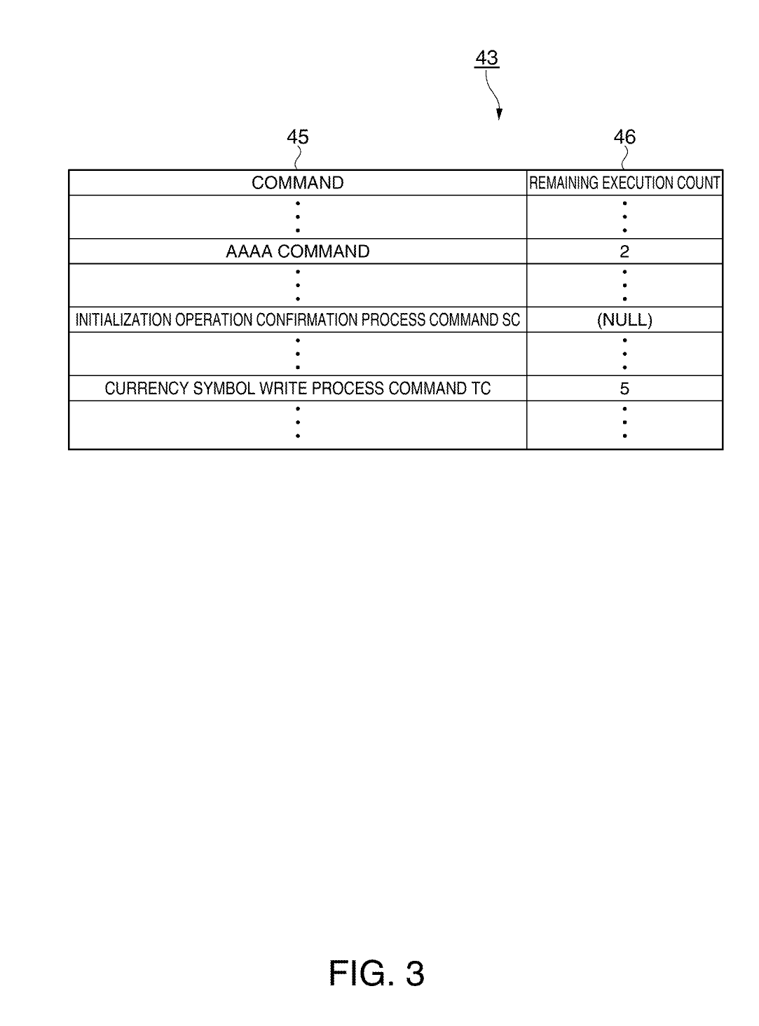

FIG. 3 schematically describes the command and initialization values table 43. An initialization process is described below as an example of a process executed when specific events occur.

The command and initialization values table 43 is a table storing a list of commands to be executed when the initialization process is executed.

Examples of specific events triggering the initialization process include the printer 12 power switching from off to on; input from the host computer 10 of a specific (defined) command for executing the initialization process; and input of an operation to the printer 12 invoking the initialization process.

The initialization process is a process that is triggered by printer power switching from off to on, triggered by input of a specific command for executing the initialization process from the host computer 10, and triggered by input of an operation telling the printer 12 to run the initialization process, and is a process including processes related to specific (defined) operations that initialize particular hardware or software components, such as resetting or clearing the CPU or RAM, and setting program variables to default or defined initial values.

The command and initialization values table 43 stores a list of settings and commands of processes that are executed when the initialization process is executed, including processes that must be executed for the printer 12 to operate normally as well as processes that should be additionally executed. When such commands or settings are registered in the command and initialization values table 43 and the initialization process is executed, the printer 12 executes the commands or settings in conjunction with the specific (defined) required initialization process.

These commands are stored in the command and initialization values table 43 in the same form as commands sent from the host computer 10, and once the printer control unit 30 reads a command from the command and initialization values table 43, the printer control unit 30 can process the command using the same procedure as for commands sent from the host computer 10.

This is described using the example of a command for writing the font data for the currency symbol in the code page 40 as shown in FIG. 2. In this example the command is written

ESC A K1 36 D1 . . . D36

where ESC declares the start of a command, A identifies the command as a function for writing font data, K1 identifies the write address, 36 is the number of bytes of font data that is written, and D1 . . . D36 denotes font data composed of 36-bytes and, in this example, denotes the font data for the currency symbol Y. This command is stored in the command and initialization values table 43, and when the printer power turns on, the printer control unit 30 reads the command and writes the 36 bytes from D1 to D36 from the address XX of K1 in nonvolatile memory 35. Note that a table showing that address XX correlates to K1 is stored in the nonvolatile memory 35. Note, further, that the command is executed the same way when the same command “ESC A K1 36 D1 . . . D36” is received from the host computer 10.

As shown in FIG. 3, each record of the command and initialization values table 43 includes at least a command field 45 and a remaining execution count field 46.

Commands to be executed when the initialization process executes, and arguments and other data required to execute the commands, are stored in the command field 45. This data may also be referred to as commands. When executing the initialization process, the printer control unit 30 reads the data stored in the command field 45 of each record in the command and initialization values table 43, and reads and executes the commands stored in the command field 45.

This command and initialization values table 43 is a table that is generated for the reason described below.

More specifically, printers 12 with a receipt printing function include advanced printers with many functions and basic printers with few functions that are both used to print receipts, have a common basic platform that includes all of the functions of the basic printer, and share a common software system that operates on the same platform. Processes that are executed as part of the initialization process may be common to both printers, and can be shared. Creating and installing separate firmware to perform different initialization processes in such cases is inefficient for development and can increase development costs. Installation can also be troublesome. Excess time is also required to modify the firmware when customization requires changing some part according to the destination.

As a result, the command and initialization values table 43 is preinstalled to the nonvolatile memory 35 in this embodiment of the invention, and processes that are performed in the initialization process and are common to different printer models are programmed into the firmware so that they can be executed as firmware functions. However, for processes that are not common to different models or are specific to a particular model, and processes that are related to customization, the required processes are registered as commands and parameter settings in the command and initialization values table 43 of the target printer. As a result, different functions and settings can be accommodated by simply changing the content of the command and initialization values table 43, at least programs related to the firmware initialization processes can be shared between different printer models, and the ease of development is improved and development costs can be reduced compared with when separate programs are developed.

The processes executed as part of the initialization process may also differ in the same model of printer depending upon the destination where the printer is sold.

In this case, the command and initialization values table 43 is preinstalled to the nonvolatile memory 35 in this embodiment of the invention, and processes performed in the initialization process that are common to all destinations are programmed in the firmware so that they can be executed as firmware functions. However, settings that differ according to the destination, such as font data settings, are registered in the command and initialization values table 43 of each printer. As a result, at least programs related to the firmware initialization processes can be shared regardless of the destination, and the ease of development is improved and development costs can be reduced compared with developing a separate program for each destination.

As shown in FIG. 3, at least an initialization operation confirmation process command SC, and a currency symbol write process command TC, are registered in the command and initialization values table 43 in this embodiment of the invention.

The initialization operation confirmation process command SC is a command for verifying hardware and software initialization operations, and is more particularly a command for running processes related to verifying initialization operations that are performed individually according to the model of printer 12 or destination separately from the initialization operations that are always performed when executing the common initialization process (an initialization operation check that is contained in the firmware and executed as a function of the firmware). The process related to this initialization operation confirmation process command SC is a process that does not involve writing data to nonvolatile memory 35. The process related to this initialization operation confirmation process command SC is also always executed in conjunction with execution of the initialization process.

The currency symbol write process command TC is a command for writing the font data for the currency symbol in the code page 40 according to the destination.

More specifically, the currency symbol in Japan is ¥, and the currency symbol in North America is $, and the currency symbol thus differs according to the destination. The process called by the currency symbol write process command TC is a process that writes font data for the currency symbol corresponding to the destination to the storage area k (storage area k1 in the example shown in FIG. 2) where font data for the currency symbol is stored in the storage areas k formed in the code page 40.

The character code or address information corresponding to the character code is sent to the printer 12. This character code or address information corresponding to the character code denotes the currency symbol, and the same information is sent regardless of the destination. In any case, the font data stored to storage area k1 is read in this embodiment. As a result, an initialization process that writes font data for the currency symbol corresponding to the destination must be written from the address XX of storage area k1 according to the destination. The destination is set using a DIP switch disposed to the printer 12 or a memory switch in the nonvolatile memory 35. The currency symbol write process command TC is executed when the printer control unit 30 power turns on, for example, reads the DIP switch setting, for example, and can write the font data for the appropriate currency symbol.

For example, the currency symbol write process command TC in a printer 12 for which the destination is set to Japan is a command that runs a process to write font data for the currency symbol ¥ to storage area k1. To execute this command, the printer control unit 30 accesses the code page 40 in nonvolatile memory 35, and writes font data for ¥ to address XX of storage area k1. The currency symbol write process command TC in a printer 12 for which the destination is set to North America is a command that runs a process to write font data for the currency symbol $ to storage area k1. To execute this command, the printer control unit 30 accesses the code page 40 in nonvolatile memory 35, and writes font data for $ to address XX of storage area k1.

The process related to the currency symbol write process command TC is thus a process that involves writing data to nonvolatile memory 35.

EEPROM, flash ROM, and other types of nonvolatile memory 35 have a limited number of write cycles assured by the manufacturer, and memory failure can result when this number is surpassed. It is therefore necessary to avoid unnecessary write operations as much as possible to avoid memory failure and extend the service life of the printer 12.

Suppressing unnecessarily writing data to nonvolatile memory 35 in conjunction with the process related to the currency symbol write process command TC is therefore desirable in this embodiment of the invention.

In addition, if processes common to different printers are included in firmware common to the printers, and processes related to different processes and customization are registered in and run from the command and initialization values table 43 using content that differs according to the printer, resources can be shared while improving development efficiency and flexibility in customization. Required processes such as writing to nonvolatile memory 35 are preferably performed individually in this case. More specifically, commands that execute processes and configure settings different from other printers are registered in the command and initialization values table 43 and executed therefrom.

However, if nonvolatile memory 35 is written every time the printer 12 power turns on from off, a specific command for running the initialization process is input from the host computer 10, or an operation for running the initialization process is applied to the printer 12, the nonvolatile memory 35 could fail sooner than expected. Avoiding writing to nonvolatile memory 35 unnecessarily is therefore preferably avoided.

More specifically, nonvolatile memory 35 is memory that stores data nonvolatilely, and the content of the code page 40 written to the nonvolatile memory 35 is held until specifically overwritten, even when printer 12 power turns off. Therefore, once the font data appropriate to the destination is stored to storage area k1 by the process called by the currency symbol write process command TC, the font data appropriate to the destination remains stored at storage area k1 until the font data stored to storage area k1 is written again. A printer 12 is typically used for its service life in the same store, and the need to change the currency symbol of a printer already in service is extremely rare.

This is used in this embodiment to limit the number of times the currency symbol write process command TC is executed during the initialization process so that the process related to the currency symbol write process command TC is not executed more than the specific (defined) number of times, thereby suppressing writing data unnecessarily to nonvolatile memory 35.

More specifically, data denoting the remaining number of times a particular command can be executed (the “remaining execution count data” below) is stored in the remaining execution count field 46 of each record in the command and initialization values table 43. This remaining number of times is preferably less than the write cycle count guaranteed by the manufacturer of the nonvolatile memory 35.

When shipped, the value of the remaining execution count data is a value denoting the maximum number of times the corresponding command can be executed, and is reduced by 1 each time a command is executed after shipping.

For example, the currency symbol write process command TC that calls a process involving writing data to the nonvolatile memory 35 cannot be executed more than 5 times. As a result, when shipped, the value of the remaining execution count for the currency symbol write process command TC is set to 5 in the command and initialization values table 43. Each time the process related to the currency symbol write process command TC is executed in conjunction with the executing the initialization process, the value of the remaining execution count is reduced 1.

This configuration enables the printer control unit 30 to manage the number of times each command is executed based on the remaining execution count data, and can avoid executing any command more than the specific number of times set as the upper limit. The printer 12 according to this embodiment of the invention is thus configured to operate based on thus managing the number of times a command executes so that commands related to processes that involve writing data to nonvolatile memory 35 are not executed more than a specific number of times. This operation is described below in further detail.

This embodiment of the invention is configured so that commands related to processes involving writing data to nonvolatile memory 35, and specifically the currency symbol write process command TC, are not executed more than the specific number of times. As described above, unless changing the destination is necessary, data only needs to be written once because the nonvolatile memory 35 is memory that stores data nonvolatilely, and there should therefore be no need for the upper limit of the number of times the currency symbol write process command TC executes to be plural.

However, depending on the results of final testing, product performance checks, and other reasons, rewriting the content of the code page 40 may be necessary prior to shipping the printer 12 after the currency symbol write process command TC has been executed in conjunction with the initialization process. So that the content of the nonvolatile memory 35 can be overwritten by executing the appropriate command in such circumstances, the maximum number of times each command can be executed can therefore be set to a plural number in this embodiment of the invention. If there is no need to change the destination and writing data once is normally sufficient, the maximum number of times value could be set to 5 considering the possible need to rewrite the value plural times due to testing, for example.

When there are commands that require executing at least plural times, executing those commands can also be enabled.

In addition, for commands that do not involve writing data to nonvolatile memory 35 but are always executed whenever the initialization process executes, such as the initialization operation confirmation process command SC, the NULL value is stored in the remaining execution count field 46 in the command and initialization values table 43 so that those commands can be executed repeatedly.

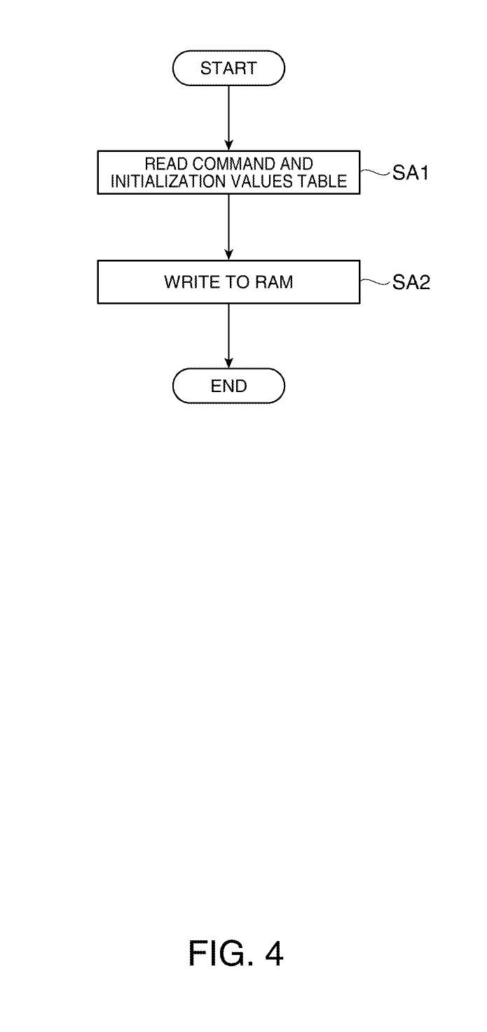

FIG. 4 is a flow chart describing the operation of the printer 12 when the power turns on.

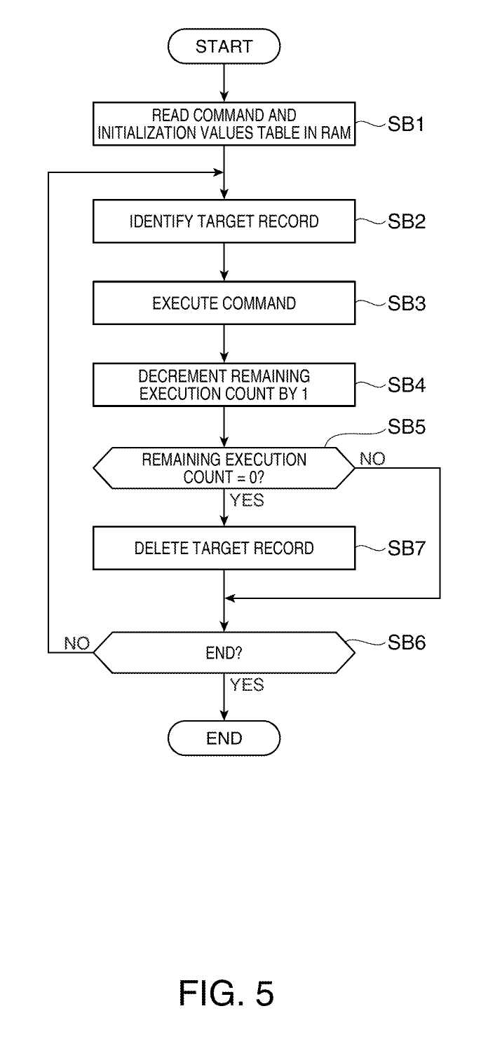

As described above, the printer 12 executes commands registered in the command and initialization values table 43 when triggered by any of plural events, including the power turning on. This operation is described with reference to FIG. 5 below, and is therefore omitted here.

As shown in FIG. 4, the printer control unit 30 of the printer 12 accesses the nonvolatile memory 35 and reads the command and initialization values table 43 when the power turns on (step SA1).

The printer control unit 30 then writes (copies) the content of the command and initialization values table 43 to RAM 37 (step SA2).

The content of the data written to RAM 37 in step SA2 must only be the same as the content of the command and initialization values table 43, and for convenience of description the command and initialization values table 43 is simply copied to RAM 37, maintaining the data format of a table composed of a set of records, in this embodiment of the invention. The data copied to RAM 37 is therefore referred to below as the command and initialization values table in RAM 37.

FIG. 5 is a flow chart of the operation of the printer 12 during the initialization process.

As noted above, the initialization process may be triggered by any of plural events. For example, the initialization process may be triggered by the power switching from off to on; input from the host computer 10 of a specific (defined) command for executing the initialization process; and input of an operation to the printer 12 invoking the initialization process.

As shown in FIG. 5, the printer control unit 30 references the command and initialization values table copied from nonvolatile memory 35 to RAM 37 (step SB1). In this case the printer control unit 30 could reference the command and initialization values table directly from nonvolatile memory 35. However, because the remaining execution count field 46 and variables such as specific flags may be overwritten, data is preferably overwritten after copying the table to RAM 37 instead of using the nonvolatile memory 35.

The printer control unit 30 then identifies any unprocessed records amongst the records of the command and initialization values table in RAM 37 (step SB2). In step SB2 the printer control unit 30 inspects the records of the command and initialization values table in RAM 37 sequentially from top to bottom, and processes the first unprocessed record found in step SB2 in step SB3. The printer control unit 30 thus assigns a flag to each record, and sets the flag (flag=1) of each record to be processed based on the trigger of the initialization process. Records to be processed (flag=1), and records not to be processed (flag=0), can be differentiated by reading the flag for each record. When the process called by a particular record ends, the printer control unit 30 sets the flag for that record to 0.

Next, the printer control unit 30 reads the command field 45 of the record selected for processing in step SB2 (the “target record” below), and executes the command stored in that field (step SB3).

The printer control unit 30 then reads the data value stored in the remaining execution count field 46 of the target record, decrements the value by 1, and saves the decreased value (step SB4).

The printer control unit 30 then determines if the value of the data stored in the remaining execution count field 46 of the target record as a result of decrementing the value by 1 in step SB4 is 0 (step SB5). If step SB5 determines that the value stored in the remaining execution count field 46 of the target record is 0, the corresponding command has been executed the number of times defined as the maximum number of times the command can be executed.

If step SB5 determines that the stored value is not 0 (step SB5 returns No), the printer control unit 30 goes to step SB6.

However, if step SB5 determines that the stored value is 0 (step SB5 returns Yes), the printer control unit 30 deletes the target record from the command and initialization values table in RAM 37 (step SB7). As a result, records corresponding to commands that have been executed the number of times defined as the maximum number of times the command can be executed are deleted from the command and initialization values table 43 in RAM 37, and those commands will thereafter not be executed. By also deleting records corresponding to commands that do not need to be executed from the table, memory can be used more efficiently in RAM 37.

Note that instead of deleting the records corresponding to commands that have been executed the number of times defined as the maximum number of times the command can be executed, those records could alternatively be identified using flags, or could be identified by storing an appropriate value in the remaining execution count field 46 of the records corresponding to those commands.

In step SB6 the printer control unit 30 determines if there is another unprocessed record included in the records stored in the command and initialization values table in RAM 37.

If all records have been processed (step SB6 returns Yes), the printer control unit 30 ends the process.

If all records have not been processed (step SB6 returns No), the printer control unit 30 returns to step SB2 and processes the next unprocessed record.

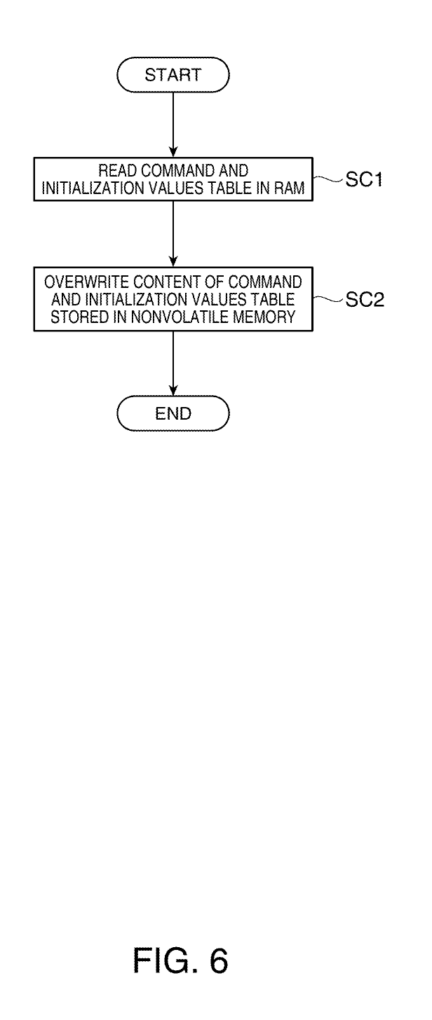

FIG. 6 is a flow chart of the printer 12 when the power turns off, and more specifically describes the operation of the printer 12 after a power off command is asserted.

As shown in FIG. 6, as part of the power shutdown operation the printer control unit 30 accesses RAM 37 and reads the command and initialization values table in RAM 37 (step SC1). Power shutdown occurs when the printer control unit 30 detects that the power switch was pressed and controls interruption of the power supply from the power supply circuit. Because the power switch does not directly cut off the power supply from the power supply circuit, and the printer control unit 30 instead controls the power shutdown operation, the power switch is a so-called software switch.

The printer control unit 30 then overwrites the content of the command and initialization values table 43 stored in nonvolatile memory 35 based on the content of the command and initialization values table in RAM 37, saving the updated content (step SC2).

More specifically, in step SC2 the printer control unit 30 deletes the records of the command and initialization values table 43 stored in nonvolatile memory 35 matching the records that were deleted from the command and initialization values table in RAM 37 by the process of step SB7 in FIG. 5. By thus deleting the records of the command and initialization values table 43 stored in nonvolatile memory 35 matching the records that were deleted in step SB7 in FIG. 5 when the power turns off, the records for commands that reached the maximum execution count will have been deleted from the command and initialization values table when the command and initialization values table is copied from nonvolatile memory 35 to RAM 37 the next time the power turns on (step SA2), and the commands corresponding to those records will not be executed.

In step SC2 the printer control unit 30 saves the values of the remaining execution count field 46 from the command and initialization values table in RAM 37 to nonvolatile memory 35. More specifically, the printer control unit 30 overwrites the value of the remaining execution count field 46 of the command and initialization values table 43 stored in nonvolatile memory 35 according to the value of the remaining execution count field 46 of the corresponding record in the command and initialization values table in RAM 37. Because the value of the field corresponding to the remaining execution count field 46 in the command and initialization values table in RAM 37 is the actual value reflecting the number of times the corresponding command has been executed, this step results in the value of the remaining execution count field 46 in the command and initialization values table 43 stored in nonvolatile memory 35 reflecting the number of times the corresponding command has been executed. Because the remaining execution count field 46 and variables such as flags are frequently overwritten, they are preferably overwritten when processed after copying to RAM 37, and copied and saved to nonvolatile memory 35 only when the power turns off. This enables reducing the number of times nonvolatile memory 35 is written.

The command and initialization values table 43 after content is written as described above is stored in nonvolatile memory 35 even after the power turns off. In this embodiment of the invention as described above, data corresponding to the command and initialization values table 43 is copied and stored to RAM 37 when the power turns on; the command and initialization values table in RAM 37 is updated appropriately as commands are executed, and the number of times each command is executed is managed based on content of the table in RAM 37 while the power is on; and the content of the command and initialization values table 43 stored in nonvolatile memory 35 is overwritten to reflect the content of the command and initialization values table in RAM 37 when the power turns off. Alternatively, only the data stored in command and initialization values table 43 that is frequently updated could be selectively copied to RAM 37 and updated as described above. The number of times nonvolatile memory 35 is written can be reduced by copying only required data to RAM 37.

An initialization process as used here is a process that is executed when triggered by specific events, such as a process that is triggered by the power switching from off to on, input from the host computer 10 of a specific command for executing the initialization process, and input of an operation to the printer 12 invoking the initialization process. The initialization process may therefore be executed plural times while the power is on. If the content of the command and initialization values table 43 stored in nonvolatile memory 35 is overwritten every time the initialization process is executed, the number of times data is written to command and initialization values table 43 increases accordingly and the life of the nonvolatile memory 35 may be shortened.

This embodiment of the invention extends the life of the nonvolatile memory 35, however, by writing to the command and initialization values table 43 stored in nonvolatile memory 35 only once when the power turns off as described above.

In addition, even when the nonvolatile memory 35 is written only once when the power turns off, values are not written again if the specified number of times a particular value can be written has been exceeded. The life of the nonvolatile memory 35 can therefore be increased even if the power is turned on and off repeatedly.

The printer 12 according to a preferred embodiment of the invention has a nonvolatile memory 35 that nonvolatilely stores data. When an initialization process is executed triggered by a specific event, the printer control unit 30 executes commands registered in a command and initialization values table 43, and does not execute commands related to processes that involve writing to the nonvolatile memory 35, such as the currency symbol write process command TC described above, more than a specified number of times.

As a result, when executing the initialization process, executing the currency symbol write process command TC, which is a command contained in the command and initialization values table 43 related to a process that involves writing to nonvolatile memory 35, more than necessary can be prevented, failure of the nonvolatile memory 35 can be avoided, and the life of the printer 12 can be extended.

In this embodiment of the invention, commands that are executed in conjunction with the initialization process are stored with information indicating the remaining number of times the command can be executed in the command and initialization values table 43. The printer control unit 30 also manages whether or not each command has been executed the specified number of times based on the information denoting the remaining number of times the command can be executed (remaining execution count data) in the command and initialization values table 43.

As a result, the printer control unit 30 can use information in the command and initialization values table 43 indicating the remaining number of times a command can be executed to appropriately manage whether or not a command has been executed more than the specified number of times, and will not execute those commands more than the specified number of times.

Of the commands contained in the command and initialization values table 43, the printer control unit 30 in this embodiment of the invention deletes those commands for which the remaining execution count has gone to zero from the command and initialization values table 43.

As a result, the command and initialization values table 43 will cease to contain commands that are prohibited from executing, a process that determines whether or not execution of a particular command is prohibited becomes unnecessary when executing commands, and command processing becomes more efficient.

The printer 12 according to this embodiment of the invention also uses volatile RAM 37 as working memory, and stores the command and initialization values table 43 in nonvolatile memory 35. When the power turns on, the printer control unit 30 copies the data corresponding to the command and initialization values table 43 stored in nonvolatile memory 35 to RAM 37, uses RAM 37 to managing writing the remaining execution count of each command in RAM 37, and when the power turns off, overwrites and saves the content of the command and initialization values table 43 stored in nonvolatile memory 35 based on the content of RAM 37. Because the guaranteed number of write cycles is greater for volatile RAM 37 than nonvolatile memory 35, this configuration is also effective for increasing the life of the printer 12.

This configuration writes the command and initialization values table 43 stored in nonvolatile memory 35 only once when the power turns off regardless of how many times the initialization process is executed while the power is on, and can therefore further suppress the number of times the nonvolatile memory 35 is written.

A preferred embodiment of the invention is described above, and various modifications and improvements that are possible within the scope of the invention will be obvious to one with ordinary skill in the related art.

For example, several examples of specific events that can trigger execution of the initialization process are described above, but the trigger events are not so limited. More specifically, the invention can also be broadly applied to recording devices that perform specific (defined) processes that are accompanied by writing data based on a corresponding specific (defined) table of information when triggered by events such as change in the output of sensors that detect ink cartridge loading, the size of paper, or opening and closing of a cover, or input or specific settings such as input from a switch panel or input of specific commands.

Furthermore, a currency symbol write process command TC is used above as an example of a command related to a process that involves writing to nonvolatile memory 35, but the invention is obviously not limited to command related to font information. Examples of other commands include any command that is related to such settings as the size or type of recording medium, the recording speed, or recording quality, or settings of processes related to optional add-on devices for the recording device, such as paper feeding devices and discharge devices, and involves writing to nonvolatile memory 35.

The printer 12 in this embodiment of the invention is a thermal printer, but the type of recording device is not so limited and the invention can also be broadly applied to printers that use other types of recording methods, including inkjet printers and dot impact printers.

The processes executed by the printer control unit 30 described above are executed by reading a program such as firmware stored in nonvolatile memory 35. The program could alternatively be stored to a hard disk drive or removable memory device instead of nonvolatile memory 35, and the printer control unit 30 could read and execute the program therefrom.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A recording device that records to a recording medium, comprising:
nonvolatile memory that stores a data table including commands that are executed when a specific event occurs and execution counts defining how many times each command can be executed; and
a control unit that executes the commands contained in the data table when the specific event occurs;
the commands in the data table including a command that writes specific information to the nonvolatile memory; and
the control unit executing said command within the range of the execution count.

2. The recording device described in claim 1, further comprising:
volatile memory;
wherein the control unit reads and writes the execution counts from the nonvolatile memory to the volatile memory,
decrements the execution count in the volatile memory when said command is executed, and
reads and writes the execution count from the volatile memory to the nonvolatile memory before the recording device power turns off.

3. The recording device described in claim 2, wherein:
the control unit deletes from the commands contained in the data table any command for which the execution count is 0.

4. The recording device described in claim 1, wherein:
the execution count is within the guaranteed number of write cycles of the nonvolatile memory.

5. The recording device described in claim 1, wherein:
the recording device can connect to a computer;
the recording device power turning on, receiving a specific command related to an initialization process from the computer, and specific input from an input unit of the recording device, are included in the specific events; and
the control unit executes a command contained in the data table when any one of the specific events is detected.

6. The recording device described in claim 5, wherein:
the commands contained in the data table are in an form that the control unit can receive from the computer and execute.

7. The recording device described in claim 1, wherein:
the commands contained in the data table include a command that writes specific font data to the nonvolatile memory.

8. The recording device described in claim 1, wherein:
firmware of which at least part is common to a different recording device is stored in the nonvolatile memory; and
the commands contained in the data table include a command that performs a different process or setting than the different recording device.

9. A method of controlling a recording device that includes nonvolatile memory storing a data table including commands that are executed when a specific event occurs and execution counts defining how many times each command can be executed, and a control unit that executes the commands contained in the data table when the specific event occurs, and records to a recording medium, wherein:
the commands in the data table including a command that writes specific information to the nonvolatile memory; and
said command is executed within the range of the execution count.

10. The method of controlling a recording device described in claim 9, wherein:
the recording device further includes volatile memory;
reads and writes the execution counts from the nonvolatile memory to the volatile memory;
decrements the execution count in the volatile memory when said command is executed; and
reads and writes the execution count from the volatile memory to the nonvolatile memory before the recording device power turns off.

11. The method of controlling a recording device described in claim 10, wherein:
the control unit deletes from the commands contained in the data table any command for which the execution count is 0.

12. The method of controlling a recording device described in claim 9, wherein:
the execution count is within the guaranteed number of write cycles of the nonvolatile memory.

13. The method of controlling a recording device described in claim 9, wherein:
the recording device can connect to a computer;
the recording device power turning on, receiving a specific command related to an initialization process from the computer, and specific input from an input unit of the recording device, are included in the specific events; and
a command contained in the data table is executed when any one of the specific events is detected.

14. The method of controlling a recording device described in claim 13, wherein:
the commands contained in the data table are in an form that the control unit can receive from the computer and execute.

15. The method of controlling a recording device described in claim 9, wherein:
the commands contained in the data table include a command that writes specific font data to the nonvolatile memory.

16. The method of controlling a recording device described in claim 9, wherein:
firmware of which at least part is common to a different recording device is stored in the nonvolatile memory; and
the commands contained in the data table include a command that performs a different process or setting than the different recording device.

17. A recording medium that can be installed in a recording device that includes nonvolatile memory storing a data table including commands that are executed when a specific event occurs and execution counts defining how many times each command can be executed, and a control unit that executes the commands contained in the data table when the specific event occurs, and records to a recording medium, and stores a program that is executed by the control unit wherein:
the commands in the data table including a command that writes specific information to the nonvolatile memory; and
the program causes the control unit to execute said command within the range of the execution count.
